(19) United States
(12) Patent Application Publication
(10) Pub. No.: US 2008/0007136 A1
(43) Pub. Date: Jan. 10, 2008

(54) Rotating electric machine having improved arrangement of brush holder for effectively dissipating heat generated by brush

(75) Inventors: Yamato Utsunomiya, Kariya-shi (JP); Kazuhiro Andoh, Okazaki-shi (JP); Tadahiro Kurasawa, Chita-gun (JP)

Correspondence Address: OLIFF & BERRIDGE, PLC, P.O. BOX 320850, ALEXANDRIA, VA, 22320-4850, US

(73) Assignee: DENSO CORPORATION, KARIYA-CITY (JP)

(21) Appl. No.: 11/808,547

(22) Filed: Jun. 11, 2007

(30) Foreign Application Priority Data
Jul. 7, 2006 (JP) 2006-188066

(51) Int. Cl. H01R 39/40

(52) U.S. Cl. 310/246; 310/245

(57) ABSTRACT

According to the present invention, there is provided a rotating electric machine which includes a field, an armature having an armature shaft and a commutator provided on the armature shaft, a brush to slide on the commutator during rotation of the armature, a brush holder holding the brush, and an end frame covering an end of the armature shaft, wherein the brush holder is directly fixed to the end frame. With such an arrangement, heat generated by the brush and transferred to the brush holder can be directly transferred from the brush holder to the end frame, thereby being effectively dissipated. Moreover, without any additional member intervening between the brush holder and the end frame, the parts count of the rotating electric machine is reduced, thus increasing the assembly accuracy and decreasing the manufacturing cost of the rotating electric machine.

### CROSS-REFERENCE TO RELATED APPLICATION

This application is based on and claims priority from Japanese Patent Application No. 2006-188066, filed on Jul. 7, 2006, the content of which is hereby incorporated by reference into this application.

### BACKGROUND OF THE INVENTION

1. Technical Field of the Invention

The present invention relates generally to rotating electric machines, such as electric generators and motors.

More particularly, the invention relates to an automotive starter motor which has an improved arrangement of brush holders for effectively dissipating heat generated by brushes during operation.

2. Description of the Related Art

Automotive starter motors generally include a commutator, brushes, and brush holders holding the brushes so as to allow the brushes to slide on the commutator during operation.

For example, Japanese Patent First Publications No. 2000-312458 and No. 2002-204553 disclose automotive starter motors in which brush holders are fixed to an end frame via a holder plate or the like.

However, with such an arrangement of the brush holders, it is difficult for heat generated by the brushes during operation to be effectively transferred to the end frame due to the holder plate or the like intervening between the brush holders and the end frame.

### SUMMARY OF THE INVENTION

The present invention has been made in view of the above-mentioned problem.

It is, therefore, a primary object of the present invention to provide a rotating electric machine which has an improved arrangement of brush holders for effectively dissipating heat generated by brushes during operation.

According to the present invention, there is provided a rotating electric machine which includes a field, an armature having an armature shaft and a commutator provided on the armature shaft, a brush to slide on the commutator during rotation of the armature, a brush holder holding the brush, and an end frame covering an end of the armature shaft. Further, the brush holder is directly fixed to the end frame.

With the above arrangement, heat generated by the brush and transferred to the brush holder can be directly transferred from the brush holder to the end frame.

Accordingly, compared to the above-described conventional starter motors, it is possible to more effectively dissipate heat generated by the brush during operation.

Further, without any additional member intervening between the brush holder and the end frame, the parts count of the rotating electric machine is reduced, thus increasing the assembly accuracy and decreasing the manufacturing cost of the rotating electric machine.

According to a further implementation of the invention, the rotating electric machine further includes a pressing member fixed to the brush holder. The commutator has a commutator surface that is perpendicular to an axial direction of the armature shaft. The pressing member presses the brush on the commutator surface in the axial direction of the armature shaft, so as to allow the brush to slide on the commutator surface during rotation of the armature.

With this configuration, the brush holder can have a pair of end faces that are opposite to each other in the axial direction of the armature shaft. From one of the end faces, the brush protrudes to make sliding contact with the commutator surface; the other end face abuts the end frame, thereby allowing heat to be directly transferred therefrom to the end frame.

In the rotating electric machine, the brush holder has a receiving portion, in which the brush is received, and a base portion. The end frame has an inner surface, on which the base portion of the brush holder abuts, and a plurality of locking portions formed on the inner surface to lock the base portion of the brush holder on the inner surface.

With this configuration, a sufficiently large contact area between the brush holder and the end frame can be secured, thereby ensuring a further effective dissipation of heat generated by the brush.

Moreover, without using any additional fixing members, such as screws, the brush holder can be more easily and reliably fixed to the end frame.

Furthermore, the locking portions of the end frame include a pair of first locking portions, which restrict movement of the base portion of the brush holder in a circumferential direction of the armature shaft, and a second locking portion that restricts inward movement of the base portion of the brush holder in a radial direction of the armature shaft.

The field includes a yoke that surrounds the armature. The base portion of the brush holder is located within the yoke so that outward movement of the base portion in the radial direction of the armature shaft is restricted by an inner surface of the yoke.

The first locking portions of the end frame are each shaped in a hook protruding from the inner surface of the end frame. Movement of the base portion of the brush holder in the axial direction of the armature shaft is restricted by the first locking portions and the inner surface of the end frame.

With the above configuration, the brush can be reliably held at a desired position with respect to the commutator, thereby ensuring high precision of the rotating electric machine.

In addition, the rotating electric machine may be an automotive starter motor.

### BRIEF DESCRIPTION OF THE DRAWINGS

The present invention will be understood more fully from the detailed description given hereinafter and from the accompanying drawings of the preferred embodiments of the invention, which, however, should not be taken to limit the invention to the specific embodiments but are for the purpose of explanation and understanding only.

In the accompanying drawings:

FIG. 1 is a partially cross-sectional side view showing an automotive starter which includes a motor according to the first embodiment of the invention;

FIG. 2 is a cross-sectional view showing a positive brush and a brush holder holding the positive brush in the motor;

FIG. 3 is a partially cross-sectional view showing a negative brush and a brush holder holding the negative brush in the motor;

FIG. 4 is a partially cross-sectional view illustrating the shape of first locking portions of an end frame in the motor;

FIG. 5 is a schematic end view illustrating locking of the brush holders on the inner surface of the end frame in the motor; and

FIG. 6 is a cross-sectional view showing a positive brush and a brush holder holding the positive brush in a motor according to the second embodiment of invention.

### DESCRIPTION OF THE PREFERRED EMBODIMENTS

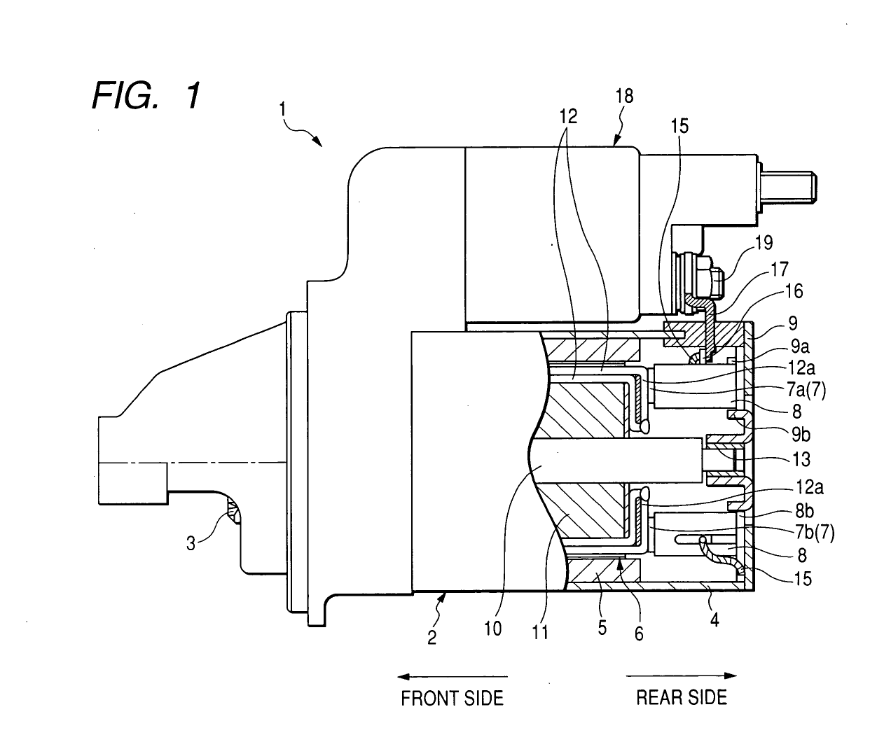

The preferred embodiments of the present invention will be described hereinafter with reference to FIGS. 1-6.

It should be noted that, for the sake of clarity and understanding, identical components having identical functions in different embodiments of the invention have been marked, where possible, with the same reference numerals in each of the figures.

### First Embodiment

This embodiment illustrates a rotating electric machine which is designed to serve as an automotive starter motor.

FIG. 1 shows an automotive starter 1 which includes a motor 2 according to the present embodiment.

The starter 1 includes the motor 2 for generating torque, and is configured to transmit the torque from a pinion gear 3 to a ring gear (not shown) of an engine (not shown), thereby starting the engine.

The motor 2 includes a field that is made up of a cylindrical yoke 4 and a plurality of permanent magnets 5 arranged on the inner periphery of the yoke 4. It should be appreciated that electromagnets may be employed instead of the permanent magnets 5 to make up the field.

The motor 2 also includes an armature 6 that is arranged radially inward of the permanent magnets 5. The motor 2 further includes brushes 7 for supplying current from a battery (not shown) to the armature 6, brush holders 8 respectively holding the brushes 7, and an end frame 9 closing a rear open end of the yoke 4.

The armature 6 includes an armature shaft 10, an armature core 11 mounted on the armature shaft 10, and an armature coil 12 wound around the armature core 11.

The armature shaft 10 has a rear end portion supported by the end frame 9 via a bearing 13 and a front end portion (not shown) connected to, for example, a speed reducer (not shown).

The armature core 11 is press-fit on the armature shaft 10 so as to rotate with the armature shaft 10. On the outer periphery of the armature core 11, there are formed a plurality of slots for holding the armature coil 12, which are spaced at even intervals in the circumferential direction of the armature shaft 10.

The armature coil 12 is provided in the slots of the armature core 11 in two-layer form. The armature coil 12 has, as shown in FIG. 1, a plurality of coil ends 12a each of which protrudes from the rear end of one of the slots of the armature core 11 and is bent to be parallel to the rear end face of the armature core 11.

All the coil ends 12a of the armature coil 12 together make up a commutator which has a commutator surface perpendicular to the armature shaft 10.

The brushes 7 include a positive brush 7a and a negative brush 7b, each of which is held by a corresponding one of the brush holders 8. The positive brush 7a is connected to a pigtail 15; the pigtail 15 is further connected to a motor lead 17 via a metal plate 16; the motor lead 17 is further connected to a motor terminal of a magnetic switch 18 of the starter 1. On the other hand, the negative brush 7b is connected to another pigtail 15, which is further connected to the end frame 9 grounded.

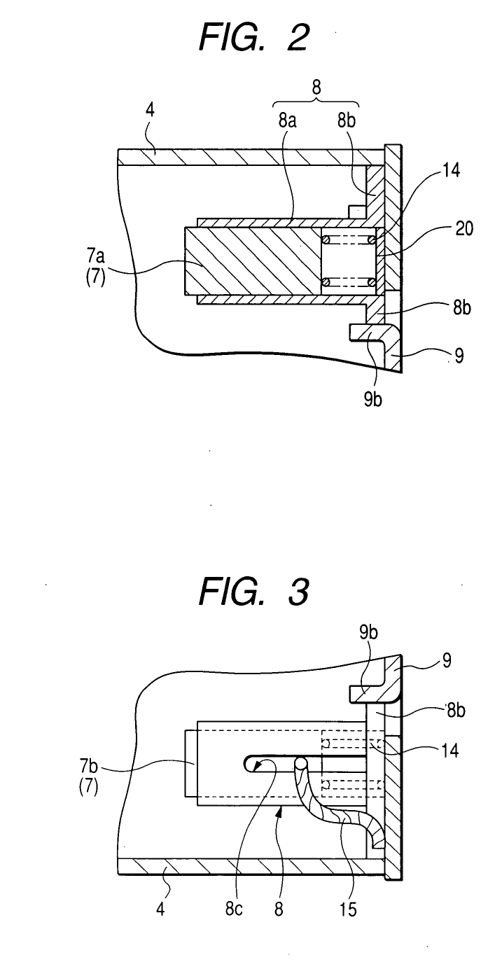

Referring further to FIGS. 2-4, in each of the brush holders 8, there is provided a brush spring 14. The brush spring 14 presses the brush 7 held in the brush holder 8 on the commutator surface, so as to allow the brush 7 to slide on the commutator surface during rotation of the armature 6.

Each of the brush holders 8 has a receiving portion 8a, in which the corresponding brush 7 is received, and a base portion 8b that is formed integrally with the receiving portion 8a.

More specifically, the receiving portion 8a is tubular in shape so as to slidably hold therein the corresponding brush 7. The receiving portion 8a has a slit 8c formed on a side face thereof, through which the pigtail 15 connected to the corresponding brush 7 is taken out of the receiving portion 8a. On the other hand, the base portion 8b is shaped in a plate that extends from a whole circumference of the rear end of the receiving portion 8a so as to be perpendicular to the longitudinal direction of the receiving portion 8a. The base portion 8b is fixed to the end frame 9, abutting on the inner surface of the end frame 9.

In addition, the brush holder 8 holding the positive brush 7a is made of an insulative material, such as resin, so as to electrically isolate the positive brush 7a from the end frame 9. Further, to prevent the positive brush 7a from being electrically connected to the end frame 9 via the brush spring 14, there is interposed an insulative plate 20 between the brush spring 14 and the end frame 9. On the other hand, the brush holder 8 holding the negative brush 7b is made of a highly heat-conductive metal, such as iron, brass, or stainless steel. It should be noted that both the brush holders 8 may also be made of the same insulative material.

The end frame 9 is made of a highly heat-conductive, easy to process, and light metal, such as aluminum. The end frame 9 has formed, on the inner surface thereof, a plurality of locking portions for locking the brush holders 8 on the inner surface.

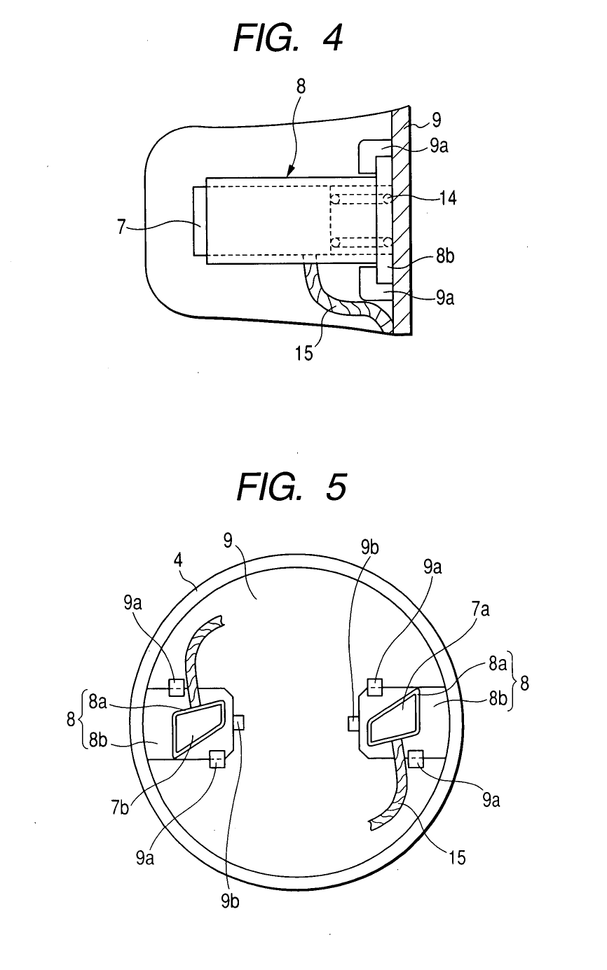

More specifically, referring to FIG. 5, the locking portions include a pair of first locking portions 9a and a second locking portion 9b for locking each of the base portions 8b of the brush holders 8. The first locking portions 9a restrict movement of the base portion 8b in the circumferential direction of the armature shaft 10, while the second locking portion 9b restricts inward movement of the same in the radial direction of the armature shaft 10. Further, as shown in FIG. 4, the first locking portions 9a are each shaped in a hook that first extends from the inner surface of the end frame 9 perpendicular to the inner surface and is then bent to be parallel to the inner surface. On the other hand, the second locking portion 9b is shaped to extend from the inner surface of the end frame 9 perpendicular to the inner surface without being bent. In addition, all the locking portions 9a and 9b are formed integrally with the end frame 9 by, for example, press working.

After having described the overall configuration of the motor 2, a method of fixing the brush holders 8 in the motor 2 will be described hereinafter.

First, prior to assembly of the end frame 9 to the yoke 4, the base portion 8b of each of the brush holders 8 is slid on the inner surface of the end frame 9 radially inward from the outer circumference of the inner surface, until it makes contact with the corresponding second locking portion 9b of the end frame 9.

Consequently, the base portion 8b becomes such that circumferential and radially inward movements thereof are respectively restricted by the corresponding first locking portions 9a and the corresponding second locking portion 9b of the end frame 9. Further, as shown in FIG. 4, the base portion 8b also becomes locked between the corresponding first locking portions 9a and the inner surface of the end frame 9 in the axial direction of the armature shaft 10. Accordingly, axial movement of the base portion 8b is restricted by the corresponding first locking portions 9a and the inner surface of the end frame 9.

Then, with the brush holders 8 locked on the inner surface thereof, the end frame 9 is assembled to the yoke 4 to close the rear open end of the yoke 4.

Consequently, as shown in FIG. 1, both the brush holders 8 are located within the yoke 4. Further, as shown in FIG. 5, the base portion 8b of each of the brush holders 8 becomes locked between the corresponding second locking portion 9b of the end frame 9 and the yoke 4 in the radial direction of the armature shaft 10. Accordingly, radially outward movement of the base portion 8b is restricted by the inner surface of the yoke 4.

The above-described motor 2 according to the present embodiment has the following advantages.

In the motor 2, the brush holders 8 are each directly fixed to the end frame 9 without any members intervening therebetween.

Consequently, heat generated by the brushes 7 and transferred to the brush holders 8 can be directly transferred from the brush holders 8 to the end frame 9.

Accordingly, compared to the conventional starter motors having a holder plate or the like interposed between the brush holders and the end frame, it is possible to more effectively dissipate heat generated by the brushes 7 during operation.

Further, without any additional member intervening between the brush holders 8 and the end frame 9, the parts count of the motor 2 is reduced, thus increasing the assembly accuracy and decreasing the manufacturing cost of the motor 2.

In the motor 2, each of the brush holders 8 has the base portion 8b that is shaped in a plate and abuts on the inner surface of the end frame 9.

Consequently, a sufficiently large contact area between each of the brush holders 8 and the end frame 9 is secured, thereby ensuring a further effective dissipation of heat generated by the brushes 7.

In the motor 2, the end frame 9 has the locking portions 9a and 9b formed on the inner surface thereof, by which the brush holders 8 are locked on the inner surface of the end frame 9.

Consequently, without using any additional fixing members, such as screws, the brush holders 8 can be more easily and reliably fixed to the end frame 9.

Further, circumferential movement of each of the brush holders 8 is restricted by the corresponding first locking portions 9a of the end frame 9; radial movement of the same is restricted by the corresponding second locking portion 9b of the end frame 9 and the inner surface of the yoke 4; and axial movement of the same is restricted by the corresponding first locking portions 9a of the end frame 9 and the inner surface of the end frame 9.

Consequently, each of the brushes 7 can be reliably held at a desired position with respect to the commutator, thereby ensuring high precision of the motor 2.

### Second Embodiment

This embodiment illustrates a formation of the brush holder 8 holding the positive brush 7a, which is different from that according the first embodiment.

As described previously, in the first embodiment, the brush holder 8 holding the positive brush 7a is made of an insulative material, such as resin, so as to electrically isolate the positive brush 7a from the end frame 9.

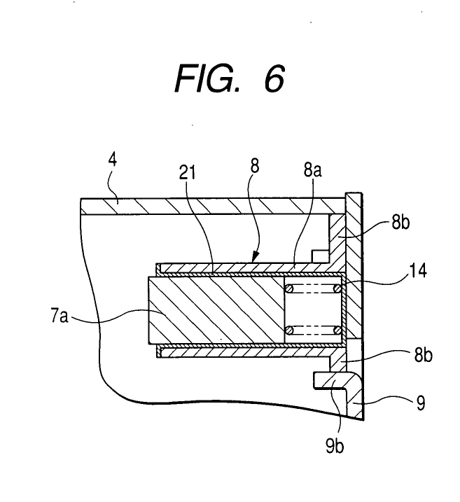

In comparison, referring to FIG. 6, in the present embodiment, the brush holder 8 holding the positive brush 7a is made of a highly heat-conductive metal, such as iron, brass, or stainless steel, and has disposed therein a cup-shaped insulator 21.

More specifically, the insulator 21 has a bottom wall abutting on the inner surface of the end frame 9 and a circumferential wall abutting on the inner surface of the receiving portion 8a of the brush holder 8. The positive brush 7a and the corresponding brush spring 14 are arranged within the insulator 21, thereby being electrically isolated from the end frame 9.

While the above particular embodiments of the invention have been shown and described, it will be understood by those who practice the invention and those skilled in the art that various modifications, changes, and improvements may be made to the invention without departing from the spirit of the disclosed concept.

For example, in the first embodiment, the commutator is configured as a surface-type commutator which has the commutator surface perpendicular to the axial direction of the armature shaft 10.

However, the commutator may alternatively be configured as a cylindrical-type commutator which is made up of a plurality of commutator segments arranged on an outer periphery of the armature shaft 10 and thus has a cylindrical commutator surface.

Moreover, in the first embodiment, the commutator is made up of the coil ends 12 protruding from the slots of the armature core 11.

However, the commutator may alternatively be made up of a plurality of commutator segments that are arranged on the rear end face of the armature core 11 and respectively connected to the coil ends 12a.

Furthermore, though the brush holders 8 are fixed to the end frame 9 by means of the locking portions 9a and 9b of the end frame 9 in the first embodiment, they may alternatively be fixed to the end frame 9 by adhesive bonding.

In addition, though the present invention is directed to an automotive starter motor in the previous embodiments, the invention is also applicable to other types of rotating electric machines.

Such modifications, changes, and improvements within the skill of the art are intended to be covered by the appended claims.

What is claimed is:

1. A rotating electric machine comprising:
a field;
an armature having an armature shaft and a commutator provided on the armature shaft;
a brush to slide on the commutator during rotation of the armature;
a brush holder holding the brush; and
an end frame covering an end of the armature shaft,
wherein the brush holder is directly fixed to the end frame.

2. The rotating electric machine as set forth in claim 1, further comprising a pressing member fixed to the brush holder, wherein the commutator has a commutator surface that is perpendicular to an axial direction of the armature shaft, and
the pressing member presses the brush on the commutator surface in the axial direction of the armature shaft, so as to allow the brush to slide on the commutator surface during rotation of the armature.

3. The rotating electric machine as set forth in claim 2, wherein the brush holder has a receiving portion, in which the brush is received, and a base portion, and
the end frame has an inner surface, on which the base portion of the brush holder abuts, and a plurality of locking portions formed on the inner surface to lock the base portion of the brush holder on the inner surface.

4. The rotating electric machine as set forth in claim 3, wherein the locking portions of the end frame include a pair of first locking portions, which restrict movement of the base portion of the brush holder in a circumferential direction of the armature shaft, and a second locking portion that restricts inward movement of the base portion of the brush holder in a radial direction of the armature shaft.

5. The rotating electric machine as set forth in claim 4, wherein the field includes a yoke that surrounds the armature, and
the base portion of the brush holder is located within the yoke so that outward movement of the base portion in the radial direction of the armature shaft is restricted by an inner surface of the yoke.

6. The rotating electric machine as set forth in claim 4, wherein the first locking portions of the end frame are each shaped in a hook protruding from the inner surface of the end frame, and
movement of the base portion of the brush holder in the axial direction of the armature shaft is restricted by the first locking portions and the inner surface of the end frame.

7. The rotating electric machine as set forth in claim 5, wherein the first locking portions of the end frame are each shaped in a hook protruding from the inner surface of the end frame, and
movement of the base portion of the brush holder in the axial direction of the armature shaft is restricted by the first locking portions and the inner surface of the end frame.

8. The rotating electric machine as set forth in claim 1, wherein the rotating electric machine is designed to serve as an automotive starter motor.
